(19) United States
(12) Patent Application Publication
(10) Pub. No.: US 2026/0018934 A1
(43) Pub. Date: Jan. 15, 2026

(54) IN SYSTEM MAGNETIC COUPLING MEASUREMENTS FOR WIRELESS POWER TRANSFER

(71) Applicant: Apple Inc., Cupertino, CA (US)

(72) Inventors: Ali Abdolkhani, Auckland (NZ); Wynand Malan, Auckland (NZ); Stephen C Terry, San Jose, CA (US)

(21) Appl. No.: 19/210,516

(22) Filed: May 16, 2025

Related U.S. Application Data
(60) Provisional application No. 63/669,517, filed on Jul. 10, 2024.
(60) Provisional application No. 63/762,176, filed on Feb. 24, 2025.

(51) Int. Cl. H02J 50/12; H02J 50/60; H02J 50/80; H02J 50/90

(52) U.S. Cl. CPC H02J 50/12; H02J 50/60; H02J 50/80; H02J 50/90

(57) ABSTRACT

Determining an indication of coupling between a wireless power transmitting coil of a wireless power transmitter and a wireless power receiving coil of a wireless power receiver can include measuring one or more circuit parameters of the wireless power transmitter with the wireless power receiving coil effectively short circuited; measuring one or more circuit parameters of the wireless power transmitter with the wireless power receiver coil open circuited; and combining the one or more circuit parameters of the wireless power transmitter measured with the wireless power receiving coil effectively short circuited with the one or more circuit parameters of the wireless power transmitter measured with the wireless power receiver coil open circuited.

### CROSS-REFERENCE TO RELATED APPLICATIONS

This patent application claims benefit of U.S. Provisional Patent Application 63/669,517, entitled “SYSTEM MAGNETIC COUPLING MEASUREMENTS FOR WIRELESS POWER TRANSFER,” filed Jul. 10, 2024, and U.S. Provisional Patent Application 63/762,176, entitled “IN SYSTEM MAGNETIC COUPLING MEASUREMENTS FOR WIRELESS POWER TRANSFER” filed Feb. 24, 2025, both of which are hereby incorporated by reference.

### BACKGROUND

Wireless power transfer is used in various electronic devices. For example, smart phones, tablet computers, smart watches, wireless earphones, styluses, etc. may employ wireless power transfer to facilitate charging of batteries within the devices. In some application, estimation, calculation, or determination of coupling factor between a wireless power transmitter and a wireless power receiver may be desirable for purposes such as regulating power transfer, detecting foreign objects, etc.

### SUMMARY

A wireless power transmitter can include: an inverter that generates an AC voltage when receiving an input voltage; a wireless power transmitting coil that receives the AC voltage from the inverter, the wireless power transmitting coil being couplable to a wireless power receiving coil of a wireless power receiver; and controller circuitry. The controller circuitry can operate the inverter to deliver power wirelessly, using the wireless power transmitting coil, to the wireless power receiver; and determine an indication of coupling between the wireless power transmitting coil and the wireless power receiving coil by combining (i) one or more circuit parameters of the wireless power transmitter measured with the wireless power receiving coil effectively short circuited with (ii) one or more circuit parameters of the wireless power transmitter measured with the wireless power receiving coil open circuited.

The indication of coupling can be a magnetic coupling coefficient determined in accordance with an equation of the form:

$$k = \sqrt{1 - \frac{{L}_{Tx , sc}}{{L}_{Tx , oc}}}$$

where L_{Tx,sc} is an inductance of the wireless power transmitting coil measured with the wireless power receiving coil effectively short circuited, and L_{Tx,oc} is an inductance of the wireless power transmitting coil measured with the wireless power receiving coil open-circuited. The the indication of coupling can be an indication of a magnetic coupling coefficient determined in accordance with an equation of the form:

$$k = \sqrt{1 - \frac{{( {f}_{oc} )}^{2}}{{( {f}_{sc} )}^{2}}}$$

where f_{sc} is a resonant frequency measured with the wireless power receiving coil effectively short circuited, and f_{oc} is a resonant frequency measured with the wireless power receiving coil open circuited. The indication of coupling can an indication of a magnetic coupling coefficient determined in accordance with an equation of the form:

$$k = \sqrt{1 - \frac{{( {f}_{oc} )}^{2}}{{( {f}_{sc} )}^{2}}} \sqrt{1 - \frac{1}{{( 2 π {f}_{sc} )}^{2} {C}_{Rx} {L}_{Rx}}}$$

where f_{sc} is a resonant frequency measured with the wireless power receiving coil effectively short circuited, f_{oc} is a resonant frequency measured with the wireless power receiving coil open circuited, C_{Rx} is a tuning capacitance of the wireless power receiver, and L_{Rx} is an inductance of the wireless power receiving coil.

The wireless power transmitter can further include a selectable tuning capacitance coupling the inverter to the wireless power transmitting coil. The selectable tuning capacitance can include one or more capacitors. The one or more circuit parameters of the wireless power transmitter measured with the wireless power receiving coil effectively short circuited can include one or more circuit parameters measured with a first value of the selectable tuning capacitance; and one or more circuit parameters measured with a second value of the selectable tuning capacitance. The one or more circuit parameters of the wireless power transmitter measured with the wireless power receiving coil open circuited can include one or more circuit parameters measured with the first value of the selectable tuning capacitance; and one or more circuit parameters measured with the second value of the selectable tuning capacitance. C_{Rx} and L_{Rx} can be determined by combining the one or more circuit parameters measured with a first value of the selectable tuning capacitance and one or more circuit parameters measured with a second value of the selectable tuning capacitance.

C_{Rx} and L_{Rx} can be determined in accordance with an equation of the form:

$${L}_{Rx} {C}_{Rx} = \frac{( {( {k}_{init \_ 1} / {k}_{init \_ 2} )}^{2} {ω}_{sc \_ 2}^{2} ) - {ω}_{sc \_ 1}^{2}}{{ω}_{sc \_ 1}^{2} {ω}_{sc \_ 2}^{2} ( {( {k}_{init \_ 1} / {k}_{init \_ 2} )}^{2} - 1 )}$$

where k_{init_1} is a coupling coefficient determined using one or more circuit parameters of the wireless power transmitter measured with the wireless power receiving coil effectively short circuited and the first value of the selectable tuning capacitance and one or more circuit parameters of the wireless power transmitter measured with the wireless power receiving coil open circuited and the first value of the selectable tuning capacitance; k_{init_2} is a coupling coefficient determined using one or more circuit parameters of the wireless power transmitter measured with the wireless power receiving coil effectively short circuited and the second value of the selectable tuning capacitance and one or more circuit parameters of the wireless power transmitter measured with the wireless power receiving coil open circuited and the second value of the selectable tuning capacitance; ω_{sc_1} is a resonant frequency measured with the wireless power receiving coil effectively short circuited and the first value of the selectable tuning capacitance; and ω_{sc_2} is a resonant frequency measured with the wireless power receiving coil effectively short circuited and the second value of the selectable tuning capacitance.

The indication of coupling can be a resistive coupling coefficient determined in accordance with an equation of the form:

$$kr = \sqrt{1 - \frac{{R}_{sc \_ 1}}{{R}_{oc \_ 1}}}$$

where R_{sc_1} is a resistance measured with the wireless power receiving coil effectively short circuited and R_{oc_1} is a resistance measured with the wireless power receiving coil open circuited. The indication of coupling can be a resistive coupling coefficient determined in accordance with an equation of the form:

$$kr = \sqrt{1 - \frac{{R}_{sc \_ 1}}{{R}_{oc \_ 1}}} \sqrt{1 - \frac{1}{{ω}_{sc} {R}_{Rx} {C}_{Rx}}}$$

where: R_{sc_1} is a resistance measured with the wireless power receiving coil effectively short circuited; R_{oc_1} is a resistance measured with the wireless power receiving coil open circuited; ω_{sc} is a resonant frequency measured with the wireless power receiving coil effectively short circuited; R_{Rx} is a resistance of the wireless power receiver; and C_{Rx} is a tuning capacitance of the wireless power receiver.

The wireless power transmitter can further include a selectable tuning capacitance coupling the inverter to the wireless power transmitting coil. The selectable tuning capacitance can include one or more capacitors. The one or more circuit parameters of the wireless power transmitter measured with the wireless power receiving coil effectively short circuited can include one or more circuit parameters measured with a first value of the selectable tuning capacitance; and one or more circuit parameters measured with a second value of the selectable tuning capacitance. The one or more circuit parameters of the wireless power transmitter measured with the wireless power receiving coil open circuited can include one or more circuit parameters measured with the first value of the selectable tuning capacitance; and one or more circuit parameters measured with the second value of the selectable tuning capacitance. C_{Rx} and R_{Rx} can be determined by combining the one or more circuit parameters measured with a first value of the selectable tuning capacitance and one or more circuit parameters measured with a second value of the selectable tuning capacitance.

C_{Rx} and R_{Rx} are determined in accordance with an equation of the form:

$${R}_{Rx} {C}_{Rx} = \frac{( {( {kr}_{init \_ 1} / {kr}_{init \_ 2} )}^{2} {ω}_{sc \_ 2} ) - {ω}_{sc \_ 1}}{{ω}_{sc \_ 1} {ω}_{sc \_ 2} ( {( {kr}_{init \_ 1} / {kr}_{init \_ 2} )}^{2} - 1 )}$$

where: kr_{init_1} is a resistive coupling coefficient determined using one or more circuit parameters of the wireless power transmitter measured with the wireless power receiving coil effectively short circuited and the first value of the selectable tuning capacitance and one or more circuit parameters of the wireless power transmitter measured with the wireless power receiving coil open circuited and the first value of the selectable tuning capacitance; kr_{init_2} is a resistive coupling coefficient determined using one or more circuit parameters of the wireless power transmitter measured with the wireless power receiving coil effectively short circuited and the second value of the selectable tuning capacitance and one or more circuit parameters of the wireless power transmitter measured with the wireless power receiving coil open circuited and the second value of the selectable tuning capacitance; ω_{sc_1} is a resonant frequency measured with the wireless power receiving coil effectively short circuited and the first value of the selectable tuning capacitance; and ω_{sc_2} is a resonant frequency measured with the wireless power receiving coil effectively short circuited and the second value of the selectable tuning capacitance.

A method of determining an indication of coupling between a wireless power transmitting coil of a wireless power transmitter and a wireless power receiving coil of a wireless power receiver, the method performed by the wireless power transmitter, can include measuring one or more circuit parameters of the wireless power transmitter with the wireless power receiving coil effectively short circuited; measuring one or more circuit parameters of the wireless power transmitter with the wireless power receiver coil open circuited; and combining the one or more circuit parameters of the wireless power transmitter measured with the wireless power receiving coil effectively short circuited with the one or more circuit parameters of the wireless power transmitter measured with the wireless power receiver coil open circuited.

The indication of coupling coefficient can be a magnetic coupling coefficient determined in accordance with an equation of the form:

$$k = \sqrt{1 - \frac{{L}_{Tx , sc}}{{L}_{Tx , oc}}}$$

where L_{Tx,sc} is an inductance of the wireless power transmitting coil measured with the wireless power receiving coil effectively short circuited, and L_{Tx,oc} is an inductance of the wireless power transmitting coil measured with the wireless power receiving coil open-circuited. The indication of coupling can be a magnetic coupling coefficient determined in accordance with an equation of the form:

$$k = \sqrt{1 - \frac{{( {f}_{oc} )}^{2}}{{( {f}_{sc} )}^{2}}}$$

where f_{sc} is a resonant frequency measured with the wireless power receiving coil effectively short circuited, and f_{oc} is a resonant frequency measured with the wireless power receiving coil open circuited. The indication of coupling can be a magnetic coupling coefficient determined in accordance with an equation of the form:

$$k = \sqrt{1 - \frac{{( {f}_{oc} )}^{2}}{{( {f}_{sc} )}^{2}}} \sqrt{1 - \frac{1}{{( 2 π {f}_{sc} )}^{2} {C}_{Rx} {L}_{Rx}}}$$

where f_{sc} is a resonant frequency measured with the wireless power receiving coil effectively short circuited, f_{oc} is a resonant frequency measured with the wireless power receiving coil open circuited, C_{Rx} is a tuning capacitance of the wireless power receiver, and L_{Rx} is an inductance of the wireless power receiving coil.

The method can further include measuring one or more circuit parameters of the wireless power transmitter with the wireless power receiving coil effectively short circuited including measuring one or more circuit parameters of the wireless power transmitter with the wireless power receiving coil effectively short circuited and a first value of a selectable tuning capacitance of the wireless power transmitter; and measuring one or more circuit parameters of the wireless power transmitter with the wireless power receiving coil effectively short circuited and a second value of the selectable tuning capacitance of the wireless power transmitter. The method can still further include measuring one or more circuit parameters of the wireless power transmitter with the wireless power receiver coil open circuited including measuring one or more circuit parameters of the wireless power transmitter with the wireless power receiving coil open circuited and the first value of the selectable tuning capacitance of the wireless power transmitter; and measuring one or more circuit parameters of the wireless power transmitter with the wireless power receiving coil open circuited and the second value of the selectable tuning capacitance of the wireless power transmitter. C_{Rx} and L_{Rx} can be determined by combining the one or more circuit parameters measured with a first value of the selectable tuning capacitance and one or more circuit parameters measured with a second value of the selectable tuning capacitance.

C_{Rx} and L_{Rx} are determined in accordance with an equation of the form:

$${L}_{Rx} {C}_{Rx} = \frac{( {( {k}_{init \_ 1} / {k}_{init \_ 2} )}^{2} {ω}_{sc \_ 2}^{2} ) - {ω}_{sc \_ 1}^{2}}{{ω}_{sc \_ 1}^{2} {ω}_{sc \_ 2}^{2} ( {( {k}_{init \_ 1} / {k}_{init \_ 2} )}^{2} - 1 )}$$

where: k_{init_1} is a coupling coefficient determined using one or more circuit parameters of the wireless power transmitter measured with the wireless power receiving coil effectively short circuited and the first value of the selectable tuning capacitance and one or more circuit parameters of the wireless power transmitter measured with the wireless power receiving coil open circuited and the first value of the selectable tuning capacitance; k_{init_2} is a coupling coefficient determined using one or more circuit parameters of the wireless power transmitter measured with the wireless power receiving coil effectively short circuited and the second value of the selectable tuning capacitance and one or more circuit parameters of the wireless power transmitter measured with the wireless power receiving coil open circuited and the second value of the selectable tuning capacitance; ω_{sc_1} is a resonant frequency measured with the wireless power receiving coil effectively short circuited and the first value of the selectable tuning capacitance; and ω_{sc_2} is a resonant frequency measured with the wireless power receiving coil effectively short circuited and the second value of the selectable tuning capacitance.

The indication of coupling can be a resistive coupling coefficient determined in accordance with an equation of the form:

$$kr = \sqrt{1 - \frac{{R}_{sc \_ 1}}{{R}_{oc \_ 1}}}$$

where R_{sc_1} is a resistance measured with the wireless power receiving coil effectively short circuited and R_{oc_1} is a resistance measured with the wireless power receiving coil open circuited. The indication of coupling can be a resistive coupling coefficient determined in accordance with an equation of the form:

$$kr = \sqrt{1 - \frac{{R}_{sc \_ 1}}{{R}_{oc \_ 1}}} \sqrt{1 - \frac{1}{{ω}_{sc} {R}_{Rx} {C}_{Rx}}}$$

where: R_{sc_1} is a resistance measured with the wireless power receiving coil effectively short circuited; R_{oc_1} is a resistance measured with the wireless power receiving coil open circuited; ω_{sc} is a resonant frequency measured with the wireless power receiving coil effectively short circuited; R_{Rx} is a resistance of the wireless power receiver; and C_{Rx} is a tuning capacitance of the wireless power receiver.

The method can further include measuring one or more circuit parameters of the wireless power transmitter with the wireless power receiving coil effectively short circuited including measuring one or more circuit parameters of the wireless power transmitter with the wireless power receiving coil effectively short circuited and a first value of a selectable tuning capacitance of the wireless power transmitter; and measuring one or more circuit parameters of the wireless power transmitter with the wireless power receiving coil effectively short circuited and a second value of the selectable tuning capacitance of the wireless power transmitter. The method can further include measuring one or more circuit parameters of the wireless power transmitter with the wireless power receiver coil open circuited including measuring one or more circuit parameters of the wireless power transmitter with the wireless power receiving coil open circuited and the first value of the selectable tuning capacitance of the wireless power transmitter; and measuring one or more circuit parameters of the wireless power transmitter with the wireless power receiving coil open circuited and the second value of the selectable tuning capacitance of the wireless power transmitter. C_{Rx} and R_{Rx} can be determined by combining the one or more circuit parameters measured with the first value of the selectable tuning capacitance and one or more circuit parameters measured with the second value of the selectable tuning capacitance.

C_{Rx} and R_{Rx} can be determined in accordance with an equation of the form:

$${R}_{Rx} {C}_{Rx} = \frac{( {( {kr}_{init \_ 1} / {kr}_{init \_ 2} )}^{2} {ω}_{sc \_ 2} ) - {ω}_{sc \_ 1}}{{ω}_{sc \_ 1} {ω}_{sc \_ 2} ( {( {kr}_{init \_ 1} / {kr}_{init \_ 2} )}^{2} - 1 )}$$

where: kr_{init_1} is a resistive coupling coefficient determined using one or more circuit parameters of the wireless power transmitter measured with the wireless power receiving coil effectively short circuited and the first value of the selectable tuning capacitance and one or more circuit parameters of the wireless power transmitter measured with the wireless power receiving coil open circuited and the first value of the selectable tuning capacitance; kr_{init_2} is a resistive coupling coefficient determined using one or more circuit parameters of the wireless power transmitter measured with the wireless power receiving coil effectively short circuited and the second value of the selectable tuning capacitance and one or more circuit parameters of the wireless power transmitter measured with the wireless power receiving coil open circuited and the second value of the selectable tuning capacitance; ω_{sc_1} is a resonant frequency measured with the wireless power receiving coil effectively short circuited and the first value of the selectable tuning capacitance; and ω_{sc_2} is a resonant frequency measured with the wireless power receiving coil effectively short circuited and the second value of the selectable tuning capacitance.

A wireless power receiver can include a wireless power receiving coil that receives an AC voltage when induced by a wireless power transmitting coil of a wireless power transmitter; a rectifier that converts the received AC voltage to a DC voltage; and controller circuitry that selectively open circuits or effectively short circuits the wireless power receiving coil to facilitate determination of an indication of coupling between the wireless power receiving coil and the wireless power transmitting coil by the wireless power transmitter by combining one or more circuit parameters of the wireless power transmitter measured with the wireless power receiving coil effectively short circuited with one or more circuit parameters of the wireless power transmitter measured with the wireless power receiving coil open circuited. The controller circuitry can selectively effectively short circuit the wireless power receiving coil using one or more switching devices of the rectifier. The controller circuitry can selectively effectively short circuit the wireless power receiving coil using one or more switching devices of the rectifier and one or more additional switching devices coupled between the wireless power receiving coil and ground.

A wireless power receiver can include a wireless power receiving coil configured to have an AC voltage induced therein by a wireless power transmitter; a rectifier that receives the AC voltage induced in the wireless power receiving coil and generates a DC rectifier output voltage; and circuitry that selectively short circuits the wireless power receiving coil. The circuitry that selectively short circuits the wireless power receiving coil can do so to facilitate measurement by the wireless power transmitter of one or more circuit parameters of the wireless power transmitter measured with the wireless power receiving coil effectively short circuited.

The controller circuitry that selectively short circuits the wireless power receiving coil can include a counter that releases the selective short circuit of the wireless power receiving coil upon counting a selected number of cycles of the AC voltage induced in the wireless power receiving coil. The circuitry that selectively short circuits the wireless power receiving coil can include a timer that releases the selective short circuit of the wireless power receiving coil after a selected time. The circuitry that selectively short circuits the wireless power receiving coil can selectively short circuit the wireless power receiving coil using one or more switching devices of the rectifier. The circuitry that selectively short circuits the wireless power receiving coil can be powered by a capacitor charged by the rectifier output voltage. The circuitry that selectively short circuits the wireless power receiving coil can be disabled upon discharge of the capacitor charged by the rectifier output voltage. The circuitry that selectively short circuits the wireless power receiving coil can be disabled responsive to a rectifier output voltage corresponding to wireless power delivery from the wireless power receiver by the wireless power transmitter.

A circuit for selectively short circuiting a wireless power receiving coil of a wireless power receiver can include at least one of a counter that releases the selective short circuit of the wireless power receiving coil upon counting a selected number of cycles of an AC voltage induced in the wireless power receiving coil by a wireless power transmitter; and a timer that releases the selective short circuit of the wireless power receiving coil after a selected time.

The circuit can short circuit the wireless power receiving coil to facilitate measurement by the wireless power transmitter of one or more circuit parameters of the wireless power transmitter measured with the wireless power receiving coil effectively short circuited. The circuit can include both the counter that releases the selective short circuit of the wireless power receiving coil upon counting the selected number of cycles of the AC voltage induced in the wireless power receiving coil by the wireless power transmitter and the timer that releases the selective short circuit of the wireless power receiving coil after the selected time.

The circuit can further include a comparator that generates an output having cycles corresponding to positive half cycles and negative half cycles of the AC voltage induced in the wireless power receiving coil by the wireless power transmitter, wherein the output is provided to the counter. The circuit can selectively short circuit the wireless power transmitting coil by turning on one or more switching devices of a rectifier of a wireless power transmitter. The circuit can further include a capacitor that charges from a rectifier of a wireless power transmitter to power the circuit.

### BRIEF DESCRIPTION OF THE DRAWINGS

FIG. 1 illustrates a simplified block diagram of a wireless power transfer system.

FIG. 2A illustrates a simplified schematic diagram of a wireless power transfer system.

FIG. 2B illustrates an alternative simplified schematic diagram of a wireless power transfer system.

FIG. 3 illustrates a flowchart of coupling coefficient estimation technique.

FIG. 4A illustrates a timing sequence for a coupling coefficient estimation technique.

FIG. 4B illustrates an alternative timing sequence for a coupling coefficient estimation technique.

FIG. 5 illustrates a schematic diagram of a circuit for selectively short circuiting a wireless power receiver coil to perform coupling coefficient estimation.

FIG. 6 illustrates exemplary waveforms associated with selectively short circuiting a wireless power receiver coil.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

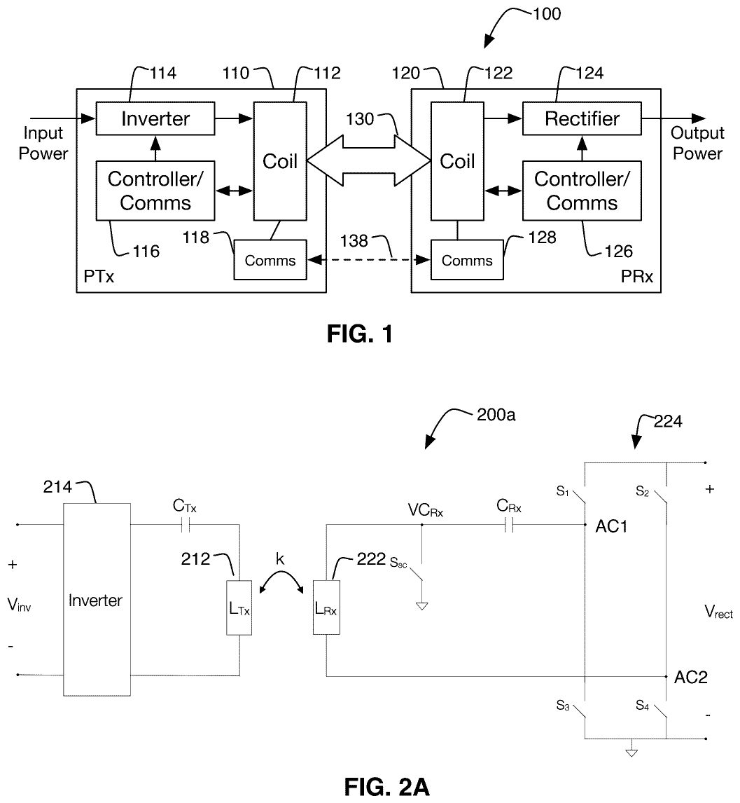

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module tag in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

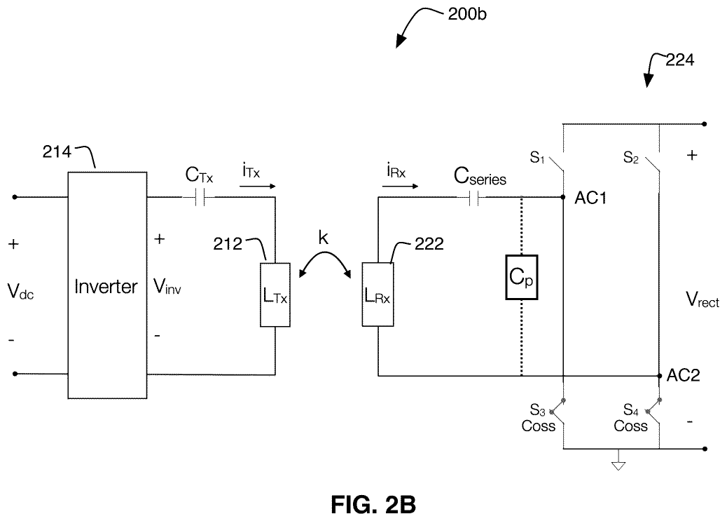

In wireless power transfer systems, it may be useful to know a magnetic coupling coefficient (also called “coupling coefficient” and sometimes denoted “k”), which is indicative of a degree of magnetic coupling between a PTx device and a PRx device. The coupling coefficient can be used for various purposes in a wireless power transfer system, such as providing an indication of a degree of alignment between a PTx device and a PRx device, indication of the presence of a foreign object in proximity to the wireless power transfer devices, etc. Thus, wireless power transfer devices may be provided with mechanisms for calculating, estimating, or determining such coupling coefficient, which can be understood with reference to the simplified schematic of a wireless power transfer system depicted in FIG. 2A.

FIG. 2A depicts a simplified schematic of a wireless power transfer system 200a. The PTx device is depicted on the left side of the figure, in which an inverter 214, generally corresponding to inverter 114 discussed above with reference to FIG. 1 can receive an input voltage Vinv. Inverter 214 can produce an AC output voltage that can be provided to a wireless power transfer coil 212 (corresponding to coil 112 discussed above and represented in FIG. 2A as an inductance LTx). Inverter 214 may be coupled to wireless power transfer coil 212 by a tuning capacitance represented in the schematic by capacitor CTx. In some embodiments a selectable tuning capacitance may be provided to allow the circuit to be tuned for different operating conditions.

With further reference to FIG. 2A, wireless power transfer coil 212 can be magnetically or inductively coupled to a wireless power transfer coil 222 (corresponding to coil 122 discussed above and represented in FIG. 2A as an inductance LRx), when the devices are in physical proximity of one another. As a result of this magnetic or inductive coupling, represented by coupling coefficient k, an AC voltage/current in wireless power transfer coil 212 can induce a corresponding AC voltage/current in wireless power transfer coil 222. This AC voltage/current can be coupled to a rectifier 224 by a tuning capacitance represented in the schematic by capacitor CRx. In some embodiments a selectable tuning capacitance may be provided to allow the circuit to be tuned for different operating conditions. In FIG. 2A, rectifier 224 is depicted as a full bridge rectifier comprised of a plurality of switching devices S1-S4. Rectifier 224 can produce a DC output voltage Vrect, which can be used for various purposes within the PRx device, such as charging a battery, powering receiver device systems, etc.

As noted above, it can be useful for various purposes to estimate coupling coefficient k. In some prior art wireless power transfer systems, an estimated coupling coefficient value kₑₛₜ has been determined in accordance with the formula:

$${k}_{est} = \frac{{C}_{0} \cdot {V}_{rect}}{{V}_{inv} + {VCTX}_{pp}} + {C}_{1}$$

where V_{rect} is the rectified voltage measured on the receiver side during startup; Vᵢₙᵥ is the inverter input voltage on the transmitter side; VCTXₚₚ is the peak-to-peak voltage measured across the transmitter tuning capacitor C_{Tx}, and C₀ and C₁ are fit coefficients obtained for a given range of coupling between a given PTx and PRx device. While the above formula can provide a usable estimate of coupling coefficient, it has certain limitations and can be improved upon.

It is desirable to determine coupling coefficient k while allowing for simplified measurements that can be performed in-field (i.e., after manufacture) without extensive pre-manufacture testing, etc. Such techniques can be based on measurements made with the receiver side wireless power transfer coil 222 (represented by inductance LRx) short circuited vs. open circuited. More specifically, the magnetic coupling coefficient k between two magnetically coupled coils can be given by:

$$k = \sqrt{1 - \frac{{L}_{Tx , sc}}{{L}_{Tx , oc}}}$$

where L_{Tx,sc} is the inductance of the Tx coil 212 measured with a short-circuited Rx coil 222, and L_{Tx,oc} is the measured inductance of the Tx coil 212 measured with an open-circuited Rx coil 222. The short circuit inductance L_{Tx,sc} and open circuit inductance L_{Tx,oc}, respectively can be given by:

$$\{ \begin{matrix}{L}_{Tx , sc} = \frac{1}{{( 2 π {f}_{sc} )}^{2} {C}_{Tx}} \\ {L}_{Tx , oc} = \frac{1}{{( 2 π {f}_{oc} )}^{2} {C}_{Tx}}\end{matrix}$$

where f_{sc} is the resonant frequency measured with the Rx coil short circuited, f_{oc} is the resonant frequency with the Rx coil open circuited, and C_{Tx} is the transmitter side tuning capacitance. Combining with the coupling coefficient determination equation above gives:

$$k = \sqrt{1 - \frac{\frac{1}{{( 2 π {f}_{sc} )}^{2} {C}_{Tx}}}{\frac{1}{{( 2 π {f}_{oc} )}^{2} {C}_{Tx}}}} = \sqrt{1 - \frac{{( {f}_{oc} )}^{2}}{{( {f}_{sc} )}^{2}}}$$

Thus, the coupling coefficient can be determined or calculated based on two transmitter side, in circuit measurements of resonant frequency, one made with the receiver side wireless power transfer coil short circuited and one with the receiver side wireless power transfer coil open circuited.

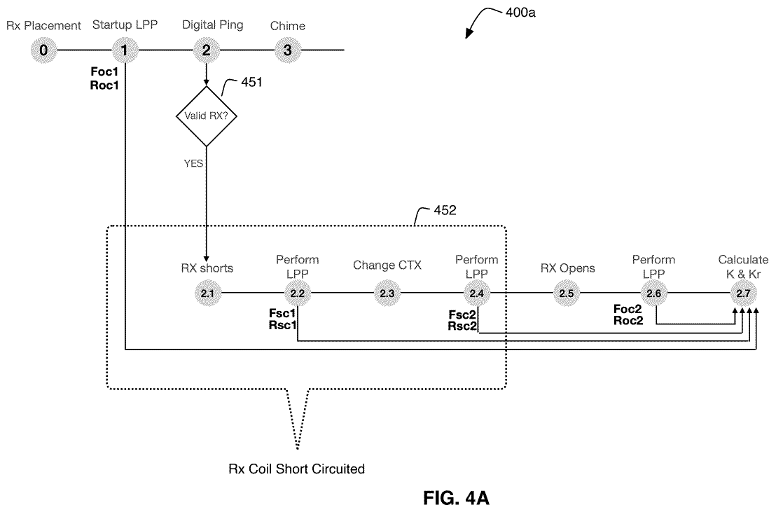

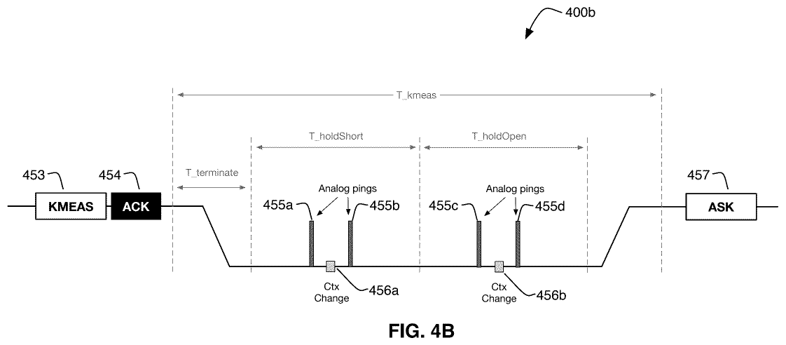

Such techniques for coupling coefficient determination are based on being able to measure circuit parameters including or corresponding to the inductance of the transmitter side wireless power transfer coil during operating conditions in which the receiver side wireless power transfer coil is open circuited and short circuited, examples of which are described in greater detail below. In general, such measurements can be performed during what is sometimes called a “low power ping” or “LPP” phase of the wireless power transfer startup sequence, described in greater detail below with respect to FIG. 4A.

As illustrated in FIG. 2B, there is at least one alternative way that the receiver side wireless power transfer coil 222 can be effectively short circuited. As used herein, “effectively short circuited” means that either the coil or the resonant tank including the coil and any tuning capacitance is short circuited, as described in greater detail below. One straightforward way is to provide an additional switch S_{sc} (FIG. 2A) specifically for the purpose of short circuiting the receiver side wireless power transfer coil 222, i.e., connecting one terminal of the coil to ground. The other terminal may be shorted/connected to ground using rectifier switch S₄. An advantage of such a configuration is that it short circuits the coil entirely, with no other components included in the circuit. A potential disadvantage of such a configuration, for at least some embodiments, is that it requires an additional switching device on the receiver side. In any case, such a circuit configuration can rely on the formulae above for coupling coefficient determination.

As an alternative, illustrated in FIG. 2B depicting a simplified schematic of a wireless power transfer system 200b, another way that the receiver side wireless power transfer coil 222 can be effectively short circuited is by closing rectifier switches S₃ and S₄. If there is no tuning capacitance (such as series tuning capacitance Cₛₑᵣᵢₑₛ or parallel tuning capacitance Cp depicted in FIG. 2B, which can correspond to tuning capacitance C_{Rx} in FIG. 2A), which may be the case in at least some embodiments, then the coil is effectively short circuited, just as in the S_{sc}/S₄ technique described above. The same is effectively true if the tuning capacitance is sufficiently large that it is used more like a DC blocking capacitor than a tuning capacitor, which may be the case for at least some PRx device designs. Otherwise, if there is a series and/or parallel tuning capacitance (Cₛₑᵣᵢₑₛ/Cₚ) of nominal value (which may be the case in at least some embodiments), then the short circuit is actually of the wireless power transfer coil and tuning capacitance, sometimes collectively described as a resonant tank. Thus, the short circuit is not just of the receiver side wireless power transfer coil, and the coupling coefficient formula described above must be altered to account for the tuning capacitance.

In this alternative, the formulae above may be adjusted to account for the fact that the receiver side tuning capacitance and any parasitic capacitances can be included in the short circuit.

More specifically, the coupling coefficient can be determined by:

$$k = \sqrt{1 - \frac{{( {f}_{oc} )}^{2}}{{( {f}_{sc} )}^{2}}} \sqrt{1 - \frac{1}{{( 2 π {f}_{sc} )}^{2} {C}_{Rx}^{′} {L}_{Rx}}}$$

where C′_{Rx} is the receiver side capacitance including all tuning and relevant parasitic capacitances, with other variables are as given above.

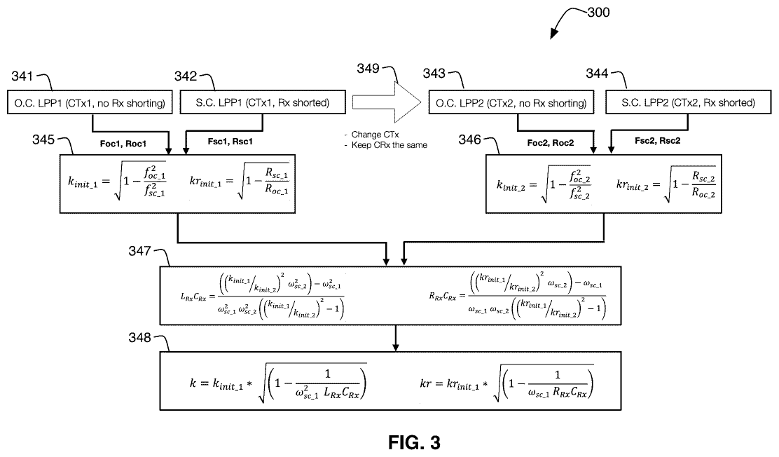

FIG. 3 illustrates a flowchart 300 depicting a coupling coefficient determination technique as described above. The steps of the flow chart can be performed by the controller circuitry of a wireless power transmitter (as was described above) or by any other suitable controller circuitry in the wireless power transfer system. The illustrated flow chart depicts determining both a magnetic coupling coefficient k and a resistive coupling coefficient kr for a wireless power transfer system that includes a switchable transmitter side tuning capacitance C_{Tx}. That is, the tuning capacitance C_{Tx} may take on two (or more values), e.g., C_{Tx1} and C_{Tx2}. In some applications, the coupling coefficient k may be an indicator used to select a tuning capacitance value. Additionally, the resistive coupling coefficient kr may be used to improve various aspects of operating or controlling a wireless power transfer system, such as improved foreign object detection. In any case, flowchart 300 depicts four separate measurement blocks 341-344. In block 341, open circuit measurements using a first transmitter side tuning capacitance value C_{Tx1} may be performed. In block 342, short circuit measurements using the first transmitter side tuning capacitance value C_{Tx1} may be performed. In block 343, open circuit measurements using a second transmitter side tuning capacitance value C_{Tx2} may be performed. In block 344, short circuit measurements using the second transmitter side tuning capacitance value C_{Tx2} may be performed. Depicted between blocks 342 and 343 is a transition arrow 349 corresponding to the change in transmitter side tuning capacitance, e.g., from C_{Tx1} to C_{Tx2}. However, the order described above and timing of the C_{Tx} transition is not critical, and the measurements may be performed in any order or with any timing, as desired. One example of such a sequence is described in greater detail below with respect to FIG. 4A, and another in FIG. 4B.

In any case, the first measurement block 341 can produce two values: the open circuit resonant frequency, depicted as Foc1, and the open circuit resistance value Roc1 (which can be used to determine the resistive coupling coefficient, as described in greater detail below). Likewise, the second measurement block 342 can produce two additional values: the short circuit resonant frequency Fsc1, and the short circuit resistance value Rsc1 (which can be used to determine the resistive coupling coefficient, as described in greater detail below). If the resistive coupling coefficient kr is not required for a particular application, the resistance measurements may be omitted. In any case, the measurements from measurement blocks 341 and 342 can be fed to an initial computation block 345. In initial computation block 345, an initial (magnetic) coupling coefficient can be computed as described above, or, more specifically, using the formula:

$${k}_{init \_ 1} = \sqrt{1 - \frac{{( {f}_{oc \_ 1} )}^{2}}{{( {f}_{sc \_ 1} )}^{2}}}$$

where k_{init_1} is the initial coupling coefficient corresponding to the first transmitter side tuning capacitance value, f_{oc_1} corresponds to the open circuit resonant frequency measurement Foc1, and f_{sc_1} corresponds to the short circuit resonant frequency measurement Fsc1. Likewise, if the resistive coupling coefficient is required for a given application, the initial resistive coupling coefficient can be computed using a similar formula:

$${kr}_{init \_ 1} = \sqrt{1 - \frac{{R}_{sc \_ 1}}{{R}_{oc \_ 1}}}$$

where kr_{init_1} is the initial resistive coupling coefficient corresponding to the first transmitter side tuning capacitance value, R_{sc_1} corresponds to the short circuit resistance measurement Rsc1, and R_{oc_1} corresponds to the open circuit resistance measurement Rsc1.

The above-described computations of initial computation block 345 give magnetic and resistive coupling coefficient values for cases in which it is not necessary to compensate for the transmitter side tuning capacitance, such as when the receiver side wireless power transfer coil can be short circuited or when the transmitter side tuning capacitance is sufficiently large that its value can be neglected. For other cases, the values determined in initial computation block can be fed into a further computation block 347 described in greater detail below to compensate for the tuning capacitance.

In cases with adjustable transmitter side tuning capacitance, this capacitance value C_{Tx} can be switched, and measurement blocks 343 and 344 can be performed. The third measurement block 343 can produce two values: the open circuit resonant frequency, depicted as Foc2, and the open circuit resistance value Roc2 corresponding to the second transmitter side tuning capacitance value. Likewise, the fourth measurement block 344 can produce two additional values: the short circuit resonant frequency Fsc2, and the short circuit resistance value Rsc2, both corresponding to the second transmitter side tuning capacitance value. If the resistive coupling coefficient kr is not required for a particular application, the resistance measurements may be omitted. In any case, the measurements from measurement blocks 343 and 344 can be fed to an initial computation block 346, which can generally correspond to initial computation block 345, described above. In initial computation block 346, an initial (magnetic) coupling coefficient (corresponding to the second transmitter side tuning capacitance value) can be computed as described above, or, more specifically, using the formula:

$${k}_{init \_ 2} = \sqrt{1 - \frac{{( {f}_{oc \_ 2} )}^{2}}{{( {f}_{sc \_ 2} )}^{2}}}$$

where k_{init_2} is the initial coupling coefficient corresponding to the second transmitter side tuning capacitance value, f_{oc_2} corresponds to the open circuit resonant frequency measurement Foc2, and f_{sc_2} corresponds to the short circuit resonant frequency measurement Fsc2. Likewise, if the resistive coupling coefficient is required for a given application, the initial resistive coupling coefficient can be computed using a similar formula:

$${kr}_{init \_ 2} = \sqrt{1 - \frac{{R}_{sc \_ 2}}{{R}_{oc \_ 2}}}$$

where kr_{init_2} is the initial resistive coupling coefficient corresponding to the second transmitter side tuning capacitance value, R_{sc_2} corresponds to the short circuit resistance measurement Rsc2, and R_{oc_2} corresponds to the open circuit resistance measurement Rsc2.

The above-described computations of initial computation block 346 give magnetic and resistive coupling coefficient values that can be used to compensate for the transmitter side tuning capacitance, such as when the receiver side wireless power transfer coil cannot be short circuited alone (e.g., when the resonant tank as a whole is short circuited) or when the transmitter side tuning capacitance is not sufficiently large that its value can be neglected. In such cases, the values determined in initial computation block can be fed into a further computation block 347.

Further computation block 347 can be performed to determine the values L_{Rx}C_{Rx} (i.e., the product of the receiver side inductance and capacitance) and R_{Rx}C_{Rx} (i.e., the product of the receiver side resistance and capacitance), which can be used to compensate the initial coupling coefficient values k_{init_1} and kr_{init_1} determined above in initial computation block 345. More specifically the quantity L_{Rx}C_{Rx} can be given by:

$${L}_{Rx} {C}_{Rx} = \frac{( {( {k}_{init \_ 1} / {k}_{init \_ 2} )}^{2} {ω}_{sc \_ 2}^{2} ) - {ω}_{sc \_ 1}^{2}}{{ω}_{sc \_ 1}^{2} {ω}_{sc \_ 2}^{2} ( {( {k}_{init \_ 1} / {k}_{init \_ 2} )}^{2} - 1 )}$$

where k_{init_1} and k_{init_2} are computed as described above with reference to initial computation blocks 345 and 346, ω_{sc_1} and ω_{sc_2} are the angular frequency (radians per second) expressions of the short circuit resonant frequency measurements Fsc1 and Fsc2 (measured in Hertz or cycles per second) as described above, i.e., ω=2πf. Likewise, if required for compensating a resistive coupling factor, the quantity R_{Rx}C_{Rx} can be given by:

$${R}_{Rx} {C}_{Rx} = \frac{( {( {kr}_{init \_ 1} / {kr}_{init \_ 2} )}^{2} {ω}_{sc \_ 2} ) - {ω}_{sc \_ 1}}{{ω}_{sc \_ 1} {ω}_{sc \_ 2} ( {( {kr}_{init \_ 1} / {kr}_{init \_ 2} )}^{2} - 1 )}$$

where kr_{init_1} and kr_{init_2} are computed as described above with reference to initial computation blocks 345 and 346, and the other parameters are as described above.

The compensating parameters L_{Rx}C_{Rx} and R_{Rx}C_{Rx} computed in further computation block 347 can then be provided to compensation block 348 in which the compensated (magnetic) coupling coefficient k can be determined by:

$$k = {k}_{init \_ 1} \sqrt{1 - \frac{1}{{ω}_{sc \_ 1}^{2} {L}_{Rx} {C}_{Rx}}}$$

where all parameters are as described above. Similarly, if a compensated resistive coupling coefficient kr is required, then the compensated resistive coupling coefficient kr can be determined by:

$$kr = {kr}_{init \_ 1} \sqrt{1 - \frac{1}{{ω}_{sc \_ 1} {R}_{Rx} {C}_{Rx}}}$$

where all parameters are as described above.

FIG. 4A illustrates a timing sequence 400a for a coupling coefficient estimation technique. Timing sequence 400a corresponds to a wireless power startup or initiation sequence, which can be initiated by a wireless power receiver (Rx) being brought into proximity with a wireless power transmitter (Tx). The startup sequence may be performed according to an industry standard, such as the Qi family of standards promulgated by the Wireless Power Consortium (“WPC”). Alternatively, the startup sequence may be performed according to a non-standard and/or proprietary technique that may be wholly or partially compatible with an industry standard startup sequence. In the illustrated example of FIG. 4A, the startup sequence can begin with the Rx being placed in proximity with the Tx, as depicted by block 0. Subsequently, a startup low power ping “LPP” operation can be performed as depicted by block 1. This low power ping can include an initial attempt at wireless power transmission by the wireless power transmitter that can provide the initial open circuit measurements Foc1 and, optionally Roc1 as described above with reference to FIG. 3. These value(s) can be provided to the coupling coefficient calculation block 2.7 described in greater detail below. If the LPP indicates that an object is present in proximity to the wireless power transmitter, then a digital ping may commence, as represented by block 2. This digital ping can include an attempt by the Tx to initiate digital communication with the Rx, for example in-band communication by FSK (frequency shift keying) of the drive signal provided by the inverter to the wireless power transmitting. If the Rx receives to the attempt to initiate digital communication, for example by in-band communication using ASK (amplitude shift keying) of the received wireless power by the rectifier, then the Tx can determine that a valid receiver device is present (block 451). Otherwise, the initiation process can restart at block 0 or 1, though such process is beyond the scope of the present disclosure.

If a digital ping process, such as that described above, results in determining that a valid receiver device is present, then coupling coefficient determination can proceed along the lines discussed above with respect to FIGS. 1-3. More specifically, the Rx can short circuit the receiver side wireless power transfer coil or the resonant tank (block 2.1) to allow for one or more resonant frequency or optional measurements to be made. In some embodiments, the Rx can short the coil and/or tank automatically as a matter of course at a predetermined time or sequence in the digital ping process. In some embodiments, the Rx can short the coil and/or tank responsive to an instruction or communication received from the Tx. In either case, the Rx can short the coil and/or tank for a predetermined time period (e.g., 100 ms). Optionally, the Rx can short the coil and/or tank until a release command is received from the Tx. The time period during which the Rx shorts the receiver side wireless power transfer coil (whether fixed or terminated responsive to a release command received from the Tx) is denoted by block 452 in FIG. 4A. Although 100 ms is one exemplary time period, this time period could take on any desired value greater or less than 100 ms, such as 10 ms, 20 ms, 50 ms, 80 ms, 120 ms, 140 ms, 150 ms, 200 ms, etc.

In any case, during the short circuit period, the Tx (e.g., the Tx controller circuitry) can perform the short circuit measurements described above. For example, during block 2.2, a first short circuit measurement can be performed that results in the first short circuit resonant frequency (Fsc1) and optionally the first short circuit resistance Rsc1, which can correspond to a first tuning capacitance value as described above with reference to FIG. 3. Then, at block 2.3, the Tx can change to a different resonant capacitance value, followed by further measurements at block 2.4. More specifically, during block 2.4, a second short circuit measurement can be performed that results in the second short circuit resonant frequency (Fsc2) and optionally the second short circuit resistance Rsc2, which can correspond to a second tuning capacitance value as described above with reference to FIG. 3. Then, in block 2.5, the Rx can open the wireless power receiver coil and/or resonant tank circuit, allowing a further measurement in block 2.6 that results in the second open circuit resonant frequency (Foc2) and optionally the second short circuit resistance Roc2, which can correspond to a second tuning capacitance value as described above with reference to FIG. 3. As noted above, the first open circuit measurements Fsc1 and Fsc2 can be performed in accordance with the startup low power ping of block 1.

Once all of the measurements have been performed, the resulting measurements can be processed by the Tx, e.g., by controller circuitry of the Tx, to determine the (magnetic) coupling coefficient k and, optionally, the resistive coupling coefficient kr in block 2.7, which can proceed as described above with reference to FIG. 3. The timing and sequencing of FIG. 4A is merely one example, and other measurement sequences can be performed in any desired order to determine the particular parameters required in any given application.

FIG. 4B illustrates an alternative timing sequence 400b for the above-described short circuit and open circuit measurements. The sequence can begin with the wireless power receiver sending a KMEAS message 453, indicating that it wishes to perform the required measurements. This can be acknowledged by an ACK message 454 from the wireless power transmitter, which can begin the measurement interval T_kmease. During this measurement interval, the wireless power transmitter can stop power transmission within the T_terminate period. During an initial short circuit interval T_holdShort, the wireless power receiver can short circuit the wireless power transfer coil (or the resonant tank), allowing the wireless power transmitter send analog pings 455a and 455b to perform the above-described measurements. Between analog pings 455a and 456b, the wireless power transmitter can switch to an alternative transmitter tuning capacitance Ctx, as described above with reference to FIG. 3. During a subsequent open circuit interval T_holdOpen, the wireless power receiver can open circuit the wireless power transfer coil (or the resonant tank), allowing the wireless power transmitter send analog pings 455c and 455d to perform the above-described measurements. Between analog pings 455c and 456d, the wireless power transmitter can switch to an alternative transmitter tuning capacitance Ctx, as described above with reference to FIG. 3. After all measurements have been performed in conjunction with the analog pings, the wireless power transmitter can resume wireless power transmission, and the wireless power receiver can engage in subsequent ASK comms (457) as required.

Other variations of the measurement timing sequences are also possible. For example, short circuit measurements could be performed after open circuit measurements, short and open circuit measurements for one tuning capacitance could be performed first, with short and open circuit measurements for a second tuning capacitance could be performed second, etc.

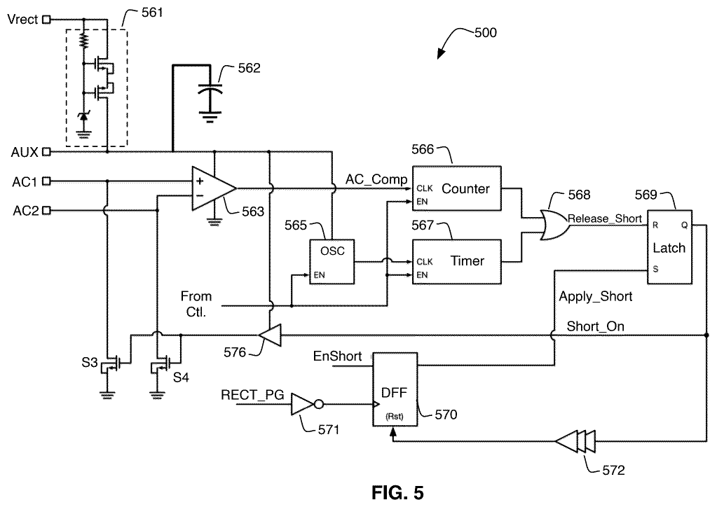

FIG. 5 illustrates a schematic diagram of a circuit 500 for selectively short circuiting a wireless power receiver coil to perform coupling coefficient estimation. Circuit 500 can be powered by the wireless power receiver's rectifier output voltage VRECT (see FIGS. 2A-2B) via circuitry 561 that can selectively connect/disconnect the rectifier output voltage to an AUX bus that powers the circuitry. For example, when Vrect is available, it can charge a power supply capacitor 562 that can be used to power the remainder of the circuitry when Vrect is not available. The illustrated arrangement of circuitry 561 and power supply capacitor 562 is just one possible arrangement, and other configurations are also possible.

Circuit 500 can also be connected to the wireless power receiving coil via terminals AC1 and AC2 (see FIGS. 2A-2B). As described above, this connection can allow effective short circuiting of the wireless power receiving coil, which can include either short circuiting the coil alone or short circuiting the coil along with any tuning circuitry, as described above. As described in greater detail below, circuit 500 can, responsive to appropriate conditions, short circuit the wireless power receiving coil to allow a wireless power transmitter to perform in circuit measurements for determining coupling factors as described above. Circuit 500 can also disable the short circuit under certain conditions to allow the resumption of wireless power transfer. For example, circuit 500 can remove the short circuit responsive to expiration of a timer, a certain number of cycles of the AC input, discharge of the power supply capacitor 562, etc.

Circuit 500 can monitor the rectifier output voltage Vrect to determine whether the wireless power receiver is receiving power from a wireless power transmitter. If so, then the RECT_PG (rectifier power good) signal applied to D-flip flop 570 (via inverter 571) can inhibit short circuiting of the wireless power receiving coil. Otherwise, if there is no Vrect voltage, wireless power transfer has stopped, and the receiving coil short circuiting operation can be enabled. A further input signal EnShort supplied to D-flip flop 570 can further allow for selective enabling or disabling of the receiving coil short circuiting operation. This EnShort signal can, for example be supplied by the wireless power receiver control circuitry discussed above with reference to FIG. 1.

In any case, upon occurrence of the conditions that trigger coil short circuiting, the Apply_Short signal that is the output of D-flip flop 570 can be supplied to latch 569, which can be, for example, an SR-flip flop. This can trigger the latch, whose output signal (Short_On) can be applied to switches S3/S4 (via driver circuitry 576) to turn them on, effectively short circuiting the wireless power receiving coil. Switches S3 and S4 can be either the low-side rectifier switches (see FIGS. 2A-2B) or can be separate switches for short circuiting the wireless power receiving coil, as was described above. In any case, once the wireless power receiving coil is short circuited, a wireless power transmitter can use its inverter or other suitable circuitry to drive the wireless power transmitting coil, which can be magnetically coupled to the wireless power receiving coil, to perform measurements such as those described above for determining the coupling factor.

The voltage across the wireless power receiving coil, i.e., the voltage between terminals AC1 and AC2 can be supplied to a comparator 563, which can deliver a positive output during positive half cycles of the AC waveform and a zero output during negative half cycles of the AC waveform (or vice-versa). The AC_Comp signal that is the output of comparator 563 can thus be a square wave with a frequency corresponding to the AC voltage across the wireless power receiving coil. This AC_Comp signal can be supplied to a counter 566 that can count the cycles associated with the short circuit measurements made by the wireless power transmitter. Counter 566 can be enabled by the control circuitry once the short circuit of the wireless power receiving coil is triggered (From Ctl. signal). Once a predetermined number of cycles have elapsed, the counter output can go high, triggering a release of the short circuit as described in greater detail below.

A release of the short circuit can also be triggered responsive to a timer. Timer 567 can also be enabled by the control circuitry and can receive as a clock input the output signal from an oscillator 565 that can also be enabled by the control circuitry. Once a predetermined time period has expired, the output of the timer can go high, triggering a release of the short circuit as described in greater detail below.

Either counter 566 or timer 567 can trigger release of the short circuit responsive to either of them reaching their respective count or time thresholds, which can be determined as appropriate for a particular application. For example, their outputs can be supplied to an OR gate 568, the output of which can in turn be provided to the reset pin of latch 569 discussed above. This can reset the latch, which can de-assert the Short_on signal provided to the short-circuiting switches S3/S4, causing them to turn off, thereby un-short circuiting the wireless power receiving coil. The latch output signal can also be provided to D-flip flop 570 via delay elements 572 to reset the flip flop thereby disabling circuitry 500.

The short circuit condition can also be released if the wireless power transmitter begins delivering power to the wireless power receiver. This operation would result in the rectifier output voltage Vrect going high, which would cause the RECT_PG signal described above to turn off D-flip flop 570. Finally, the short circuit condition can also be released if the power supply capacitor 562 discharges, which will de-power circuit 500, thereby de-asserting any drive signal supplied to short circuiting switches S3/S4.

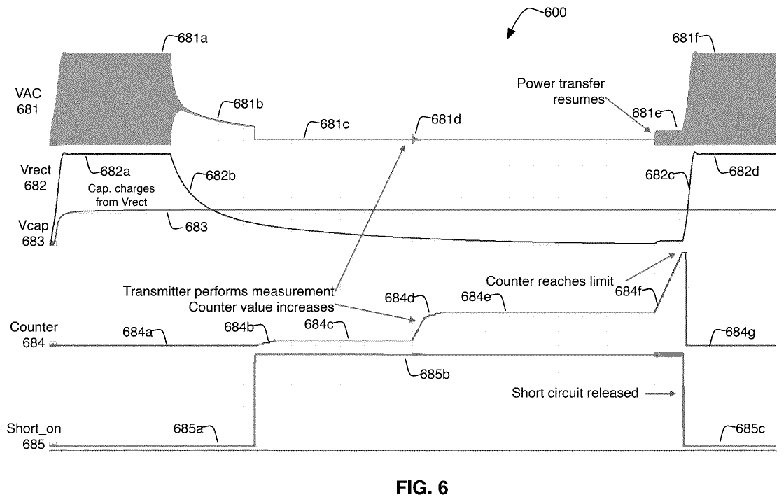

FIG. 6 illustrates a plot 600 of exemplary waveforms associated with selectively short circuiting a wireless power receiver coil derived from a circuit simulation of circuit 500 described above. Waveform 681 illustrates the AC voltage across the wireless power transfer coil and is illustrated in waveform segments 681a-681f. Waveform segment 681a corresponds to a time period when a wireless power transmitter is delivering power to the wireless power receiver. This region appears solid because the frequency of the AC voltage is substantially higher than the time scale of FIG. 6. Waveform segment 681b corresponds to a decay of the AC voltage when the wireless power transmitter stops delivering power to the wireless power receiver, eventually reaching a zero value when the wireless power receiving coil is short circuited, as illustrated by waveform segment 681c. Waveform segment 681d corresponds to the measurements performed by the wireless power transmitter as described above. Wireless power transfer then resumes, as illustrated by waveform segment 681e, which starts at a lower voltage initially and then can transition to a higher voltage illustrated by waveform segment 681f.

Waveform 682 illustrates the rectifier output voltage Vrect and is illustrated in waveform segments 681a-681d. Waveform segment 682a illustrating a constant value corresponding to the period when the wireless power transmitter is delivering power to the wireless power receiver. Waveform segment 682b illustrates the rectifier output voltage Vrect when the wireless power transmitter is not delivering power, during which the rectifier voltage decays until wireless power transfer is resumed, at which point the rectifier voltage Vrect increases (waveform segment 682c) until reaching its nominal constant value (waveform segment 682d).

Waveform 683 illustrates the voltage across the capacitor 562 that powers circuit 500. As can be seen, the capacitor initially charges from the rectifier output voltage and then remains at a relatively constant level, thereby allowing capacitor 562 to power operation of circuit 500 as described above with reference to FIG. 5.

Waveform 684 corresponds to the value of counter 566 and is illustrated in segments 684a-684g. In waveform segment 684a, the counter value is at zero, as the counter is disabled. Once the wireless power receiving coil is short circuited, waveform segment 684b illustrates a slight increase in the counter value, which could be, for example, associated with ringing of the circuit and/or open circuit measurements being performed by the wireless power transmitter. Once the wireless power receiving coil stabilizes in the short circuited condition, the counter remains constant at a low level, corresponding to waveform segment 684c. Then, when the wireless power transmitter begins its measurements (corresponding to waveform segment 681d above), the counter value increases in connection therewith. The counter can then stabilize at a value corresponding to waveform segment 684e until wireless power transfer resumes at which point it will again increase, as illustrated by waveform segment 684f. Finally, once the counter reaches its threshold value (or the timer described above reaches its timeout value), the short circuit condition can be removed, which can also cause a reset of the counter, causing its value to return to zero as illustrated by waveform segment 684g.

Waveform 685 illustrates the Short_On signal applied to the short-circuiting switches, as illustrated in FIG. 5. In waveform segment 685a, this signal is low, indicating that the short-circuiting switches S3/S4 have not yet been turned on. Waveform segment 685b corresponds to the interval when this signal is high, short circuiting the wireless power receiving coil. Finally, when the short circuit is released (based on one of the conditions described above, such as the counter or timer reaching a predetermined threshold), the signal returns to zero, turning off switches S3/S4.

Described above are various features and embodiments relating to coupling coefficient calculation, estimation, or determination to improve wireless power transfer in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by determine the level of inductive coupling between the wireless power transmitter and receiver devices. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A wireless power receiver comprising:
a wireless power receiving coil that receives an AC voltage when induced by a wireless power transmitting coil of a wireless power transmitter;
a rectifier that converts the received AC voltage to a DC voltage; and
controller circuitry that selectively open circuits or effectively short circuits the wireless power receiving coil to facilitate determination of an indication of coupling between the wireless power receiving coil and the wireless power transmitting coil by the wireless power transmitter by combining one or more circuit parameters of the wireless power transmitter measured with the wireless power receiving coil effectively short circuited with one or more circuit parameters of the wireless power transmitter measured with the wireless power receiving coil open circuited.

2. The wireless power receiver of claim 1 wherein the controller circuitry selectively effectively short circuits the wireless power receiving coil using one or more switching devices of the rectifier.

3. The wireless power receiver of claim 1 wherein the controller circuitry selectively effectively short circuits the wireless power receiving coil using one or more switching devices of the rectifier and one or more additional switching devices coupled between the wireless power receiving coil and ground.

4. A wireless power receiver comprising:
a wireless power receiving coil configured to have an AC voltage induced therein by a wireless power transmitter;
a rectifier that receives the AC voltage induced in the wireless power receiving coil and generates a DC rectifier output voltage; and
circuitry that selectively short circuits the wireless power receiving coil.

5. The wireless power receiver of claim 4 wherein the circuitry that selectively short circuits the wireless power receiving coil does so to facilitate measurement by the wireless power transmitter of one or more circuit parameters of the wireless power transmitter measured with the wireless power receiving coil effectively short circuited.

6. The wireless power receiver of claim 4 wherein the controller circuitry that selectively short circuits the wireless power receiving coil includes a counter that releases the selective short circuit of the wireless power receiving coil upon counting a selected number of cycles of the AC voltage induced in the wireless power receiving coil.

7. The wireless power receiver of claim 4 wherein the circuitry that selectively short circuits the wireless power receiving coil includes a timer that releases the selective short circuit of the wireless power receiving coil after a selected time.

8. The wireless power receiver of claim 4 wherein the circuitry that selectively short circuits the wireless power receiving coil selectively short circuits the wireless power receiving coil using one or more switching devices of the rectifier.

9. The wireless power receiver of claim 4 wherein the circuitry that selectively short circuits the wireless power receiving coil is powered by a capacitor charged by the rectifier output voltage.

10. The wireless power receiver of claim 8 wherein the circuitry that selectively short circuits the wireless power receiving coil is disabled upon discharge of the capacitor charged by the rectifier output voltage.

11. The wireless power receiver of claim 4 wherein the circuitry that selectively short circuits the wireless power receiving coil is disabled responsive to a rectifier output voltage corresponding to wireless power delivery from the wireless power receiver by the wireless power transmitter.

12. A circuit for selectively short circuiting a wireless power receiving coil of a wireless power receiver, the circuit comprising at least one of:
a counter that releases the selective short circuit of the wireless power receiving coil upon counting a selected number of cycles of an AC voltage induced in the wireless power receiving coil by a wireless power transmitter; and
a timer that releases the selective short circuit of the wireless power receiving coil after a selected time.

13. The circuit of claim 12 wherein the circuit short circuits the wireless power receiving coil to facilitate measurement by the wireless power transmitter of one or more circuit parameters of the wireless power transmitter measured with the wireless power receiving coil effectively short circuited.

14. The circuit of claim 12 wherein the circuit comprises both the counter that releases the selective short circuit of the wireless power receiving coil upon counting the selected number of cycles of the AC voltage induced in the wireless power receiving coil by the wireless power transmitter and the timer that releases the selective short circuit of the wireless power receiving coil after the selected time.

15. The circuit of claim 12 further comprising a comparator that generates an output having cycles corresponding to positive half cycles and negative half cycles of the AC voltage induced in the wireless power receiving coil by the wireless power transmitter, wherein the output is provided to the counter.

16. The circuit of claim 12 wherein the circuit selectively short circuits the wireless power transmitting coil by turning on one or more switching devices of a rectifier of a wireless power transmitter.

17. The circuit of claim 12 further comprising a capacitor that charges from a rectifier of a wireless power transmitter to power the circuit.
